(19) United States
(12) Patent Application Publication
(10) Pub. No.: US 2010/0088238 A1
(43) Pub. Date: Apr. 8, 2010

(54) Method and system utilizing an interactive, descending, sale-price meter used to optimize negotiation-free, sales offers

(76) Inventor: Melissa Rae Butterfield, Post Falls, ID (US)

Correspondence Address: Melissa R. Butterfield, 1700 N. Spokane St., Post Falls, ID, 83854, US

(21) Appl. No.: 12/286,892

(22) Filed: Oct. 3, 2008

(51) Int. Cl. G06Q 30/00; G06Q 50/00

(52) U.S. Cl. 705/80; 705/400; 705/26

(57) ABSTRACT

A method and system to determine a fair sales price for items displayed on an advertising space with connectivity to the internet. This method and system facilitates negotiation free, transactions (like, but not limited to, real-estate sales) regulated by a unique fluctuating, regressive, digitally displayed sale price in an interactive, electronic advertising space utilizing a database. The system includes algorithms that are hosted on a server such that space is provided for property owners and prospective buyers to determine an acceptable offer on advertised property. Set parameters, which regulate the sale price amount displayed on the property's advertisement. This interactive, digital/graphic, sale-price display which regressively descends at varying rates, as manipulated by the property listing representative registered with the system, until the displayed sale price is selected by a buyer. Once the buyer offer is submitted, the host application stops further price deductions and accepts the offer for closing.

### BACKGROUND OF THE INVENTION

Owners of real property, such as the lending organizations, face a dilemma of trading off between the cost of continued ownership and the cost of liquidation. Liquidations are generally less expensive than continued ownership, but can be financially justified when sufficient real value can be identified or seen as existing by a potential buyer. Traditional methods employed for liquidations require negotiations which take time. Time being money in many instances, can be reduced significantly through open communications, more specifically, top dollar for buyer communicated and bottom dollar for seller/liquidator communicated. Many sellers are willing to accept lower than asked price as day to day cost of property ownership continues to rise. There is a point in a declining property value market where it may become economically prudent to stop negotiations at large (advertising) and sell a property below established price, so as to minimize losses.

Negotiation establishes that both parties want a fair price derived by the completion of the negotiated transaction and in many cases agents are hired to represent the seller and buyer. The act of adding seller agents and buyer agents further slows communication time and extend the negotiation process.

Therefore, there exists an unmet need to conduct property negotiations in a less costly manor.

### SUMMARY OF THE INVENTION

The present invention reduces time and cost required to develop a business case for proposed liquidations of unwanted or unwarranted properties or personal assets. By providing continuous, even real-time communication through World Wide Web advertising of a declining sales price on advertised personal property greatly reducing the time and cost associated with property transactions and sales negotiations.

The present invention provides a system that facilitates negotiation-flee, real-estate sales offers regulated by a unique fluctuating, regressive, digital, sale-price display in an interactive, electronic advertising space utilizing a www server database.

The system includes transaction algorithms driving a transaction application that is hosted on a server such that an advertising space is provided for property owners and prospective buyers to determine an acceptable offer/sale price on advertised property. The owners register their properties in the advertising space such that the prospective buyers can see the listed price descending at a predetermined rate that was selected by the sellers. The buyers see the descending digital sale price in real-time and are not aware of competing buyers' interests, nor are the buyers aware of the seller/owner's minimum price setting predetermined when registering the property. The prospective buyer studies the unique fluctuating, digital, regressive, price-meter display, uses the communication space provided to question purchase details if needed, and places an offer for purchase of the property when the regressive sale price listed is equal to the acceptable offer level the prospective buyer desires to submit to the property owner. Once the buyer's offer is submitted, the host application stops further price deductions and accepts the offer for closing.

### BRIEF DESCRIPTION OF THE DRAWINGS

The preferred and alternative embodiments of the present invention are described in detail below with reference to the following drawings.

FIG. 1 is a block diagram of an exemplary system formed in accordance with the present invention;

FIG. 2 is a flow diagram and an illustrative view of the listing process for the property owner for the system shown in FIG. 1; and

FIG. 3 is a flow diagram and an illustrative view of the listing process for a prospective buyer for the system shown in FIG. 1; and

FIG. 4 is a flow diagram and an illustrative view of the preferred and alternative embodiments of the advertising site for the system shown in FIG. 1; and

FIG. 5 is a flow diagram and an illustrative view of the method of transaction optimization; and

FIG. 6 is an illustrative view of the unique fluctuating regressive price scale formed in accordance with the present invention; and

FIG. 7 is an illustrative view of the unique transaction method and process performed by the system show in FIG. 1.

### DETAILED DESCRIPTION OF THE INVENTION

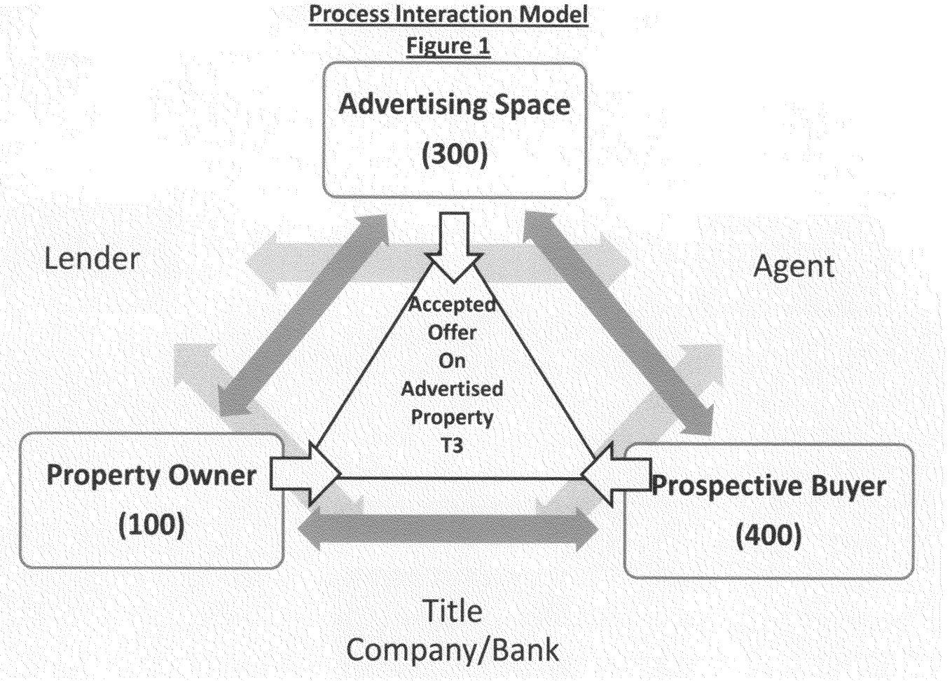

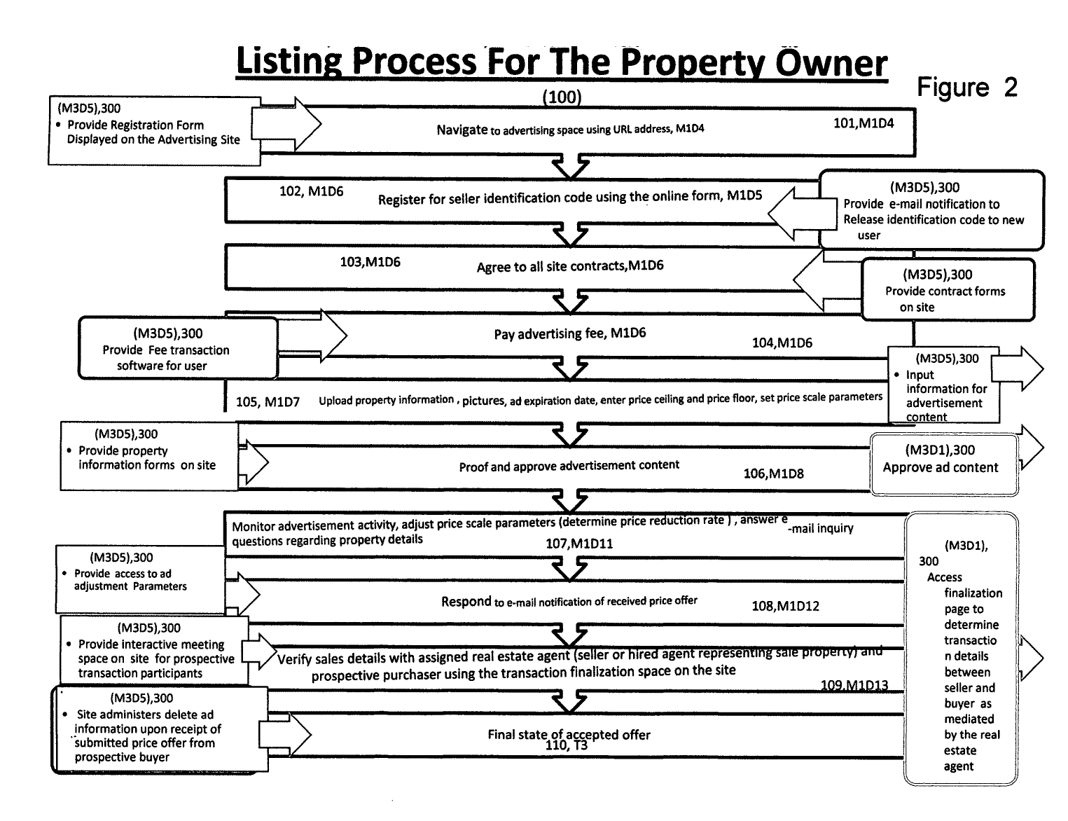

FIG. 1 illustrates a non-limiting example of a system 600 located in a web based advertising space environment where owner 100, such as a current owner, for determining transaction optimization with a future owner 400 of the real property. FIGS. 2, 3, and 4 illustrate transaction inputs and outputs as transaction contributions that are explained in detail under each FIGS. 2, 3, and 4 explanation.

FIG. 2 is a perspective view of an owner, such as a real property owner 100. Ten transaction events are shown, 101 through 110, of the real property 100. This method and system of interactive, electronic commerce serves described affiliate named in FIG. 2 by providing advertisement space for sale property and comprises steps necessary for described user to finalize item sale (IS). The designation of a user is determined by information provided on the registration form as completed by the intended owner participant. The fluctuating variables engage the users with interactive parameters that optimize and drive the offer exchange opportunity toward the mutual objective of an accepted price offer for the advertised property. By offering a unique property, monitoring-screen option to registered users, multiple properties are loaded and saved in one area on the site providing a more detailed analysis.

Each numbered transaction provides the bases for a computational approach which represents the dynamics of this interactive process where certain indicators represent the sequential criteria necessary to achieve the end state system objective as defined by this model. This gives a firm bases for any simplification of the identifiable criteria to achieve the desired objective of a negotiation-free accepted offer as determined by both the seller and the buyer. Equation 1 sums the transition illustrated in FIG. 2.

(M1D1, M1D4)+M1D5+M1D6+M1D7+M1D8+M1D11+M1D13=T1 Equation 1

This method and system advertises sale items listed by registered users, as shown in FIG. 2.

The affiliate defined in FIG. 2 completes all preliminary sales obligations commonly required by real-estate agents when listing a property utilizing a brokerage firm or similar agency.

This method and system utilizes a basic registration protocol that releases an identification code to inquiring participants upon completion of the registration form. The assigned identification codes permit access to various pages/forms within the system's WWW database.

Equation 1 transaction details are as follows:

M1D1 This method and system of interactive transitions, electronic commerce serves described affiliate M1D1 listed in field 100 of FIG. 1 by providing advertisement space for sale property and comprises steps necessary for described user to finalize item sale (IS). The designation of a user is determined by information provided on the registration form as completed by the intended participant. The fluctuating variables engage the users with interactive parameters that optimize and drive the offer exchange opportunity toward the mutual objective of an accepted price offer for the advertised property. By offering a unique property monitoring screen options to registered users, multiple properties are loaded and saved in one area on the site providing a more detailed analysis.

M1D2 The described system displays advertised sale items listed by registered users.

M1D3 The affiliate defined in FIG. 2. completes all preliminary sales obligations commonly required by real-estate agents when listing a property utilizing a brokerage firm or similar agency.

M1D4 The system includes transaction algorithms, drive a transaction application that is hosted on a server such that an advertising space is provided for property owners and prospective buyers to determine an acceptable offer on advertised property. The asset owners register their properties in the advertising space by navigating to the advertised URL.

M1D5 This method and system of transactions utilizes a basic registration protocol that releases an identification code to inquiring participants upon completion of the registration form and paying site usage fees. The assigned identification codes permits access to various pages/forms within the system's WWW server database.

M1D6 The system requires transactors to apply for both a seller's identification code and a user's payment account if they intend to advertise property for sale on the WWW server database. Upon completion of the registration forms, listing fees are charged to the user's account, and payment is required before further database access is permitted. The final step in the registration process is to secure the approval of all legal contracts by said inquiry required for system use and transaction participation.

M1D7 This method and system authorizes access to entry fields (listing windows) for posting legal descriptions of property, pictures, starting sale price, advertisement expiration date, listing representative or sales agents e-mail address, and item descriptions. Next, system parameters are set by the listing representative (seller/agent/broker/) such as the sale price floor and initial setting of the rate at which the regressive price meter will drop the advertised sale price over the advertised time period. The listing representative/property/item owner has alternative pricing options available to alter the price reduction amount and rate of decline to optimize the final sale price. The price reduction rate may change, but the price may not remain fixed or increase at any time during the advertisement period. These parameters are not disclosed for public view and are for administrative use only. Upon completion of the user registration and product registration the entries are uploaded to the site's database using the World Wide Web.

M1D8 The method and system provides an interactive platform to facilitate communication between site administration and listing representatives to ensure accurate advertisement content before advertisement is released for public view. Final ad content proofing is completed by the designated listing representative.

M1D9 The method and system provides administrative services to registered users and reserves the right to release the uploaded property advertisement to the site for view by the public upon completion of steps M1D1 through M1D8 of this method and system.

M1D11 This method and system provides registered items advertisement space on the WWW site which includes extended pages for more advertisement information. Every advertisement listing displays a picture and the digital display of the decreasing/regressive purchase price (meter) which is regulated solely by the designated listing representative and is represented by a dollar and cent counter that is scrolling regressively at a designated rate of change, twenty-four hours a day. At any time, the designated listing representative may alter the rate of change for the sale-price meter displayed on the property's advertisement by increasing the speed of the descending sale-price meter (scale) or decreasing the speed of the descending price meter (scale) display as stated in claim 1. The price may not increase at any time. The above described price manipulation continues until the designated item has been selected by another registered user for purchase or the predetermined advertisement time expires or the lowest acceptable sale price determined at time of property registration reaches/matches the descending sale price amount displayed on the advertisement.

This method and system facilitates the sale of listed items free of negotiation. Transaction proceedings begin when a purchaser enters an identification code in the designated field on the item's advertisement. The sale price meter is frozen in the system and is recorded in the database to the dollar and cent for that purchase. The descending price meter is visible to the public at all times.

M1D12 This method and system incorporates all legal documents to secure sales transactions for both the buyer and seller. Upon the sellers notification of accepted fair-market-price for sale item, the system will automatically notify the seller's account or listing representative's account within the system's database, and send a confirmation e-mail to both parties which activates the sale, and provides the system link address for quick and easy transaction finalization. Both parties involved in the sales transaction will work with the seller's real-estate agent to finalize the sales transaction. All real-estate property sold using this method and system will utilize a sales agent for the final state (IS) transactions.

If said parties determine that transactions will not be finalized due to irreconcilable circumstances, the property will be permitted for continued advertisement on the www server. However, listing representative retains the right to modify system settings and reset the starting scale price if desired. Additional listing fees will be charged to the user's account upon reposting. In the situation that multiple users select the advertised property the seller retains the right to accept the next sold price received simply by not removing advertisement from the system database or stopping the price meter. The reposting of an advertisement will require a posting fee to be paid before advertisement will continued or access will be permitted for user to reset system parameters.

M1D13 This method and system facilitates the sales transactions where users advertise items by posting a fluctuating sale price and users agree to purchase items simply by agreeing to pay the advertised sale price which upon completion of all system required steps, as defined in this invention, will result in a negotiation free transaction taken to the final state of item sale(IS) and product release from database.

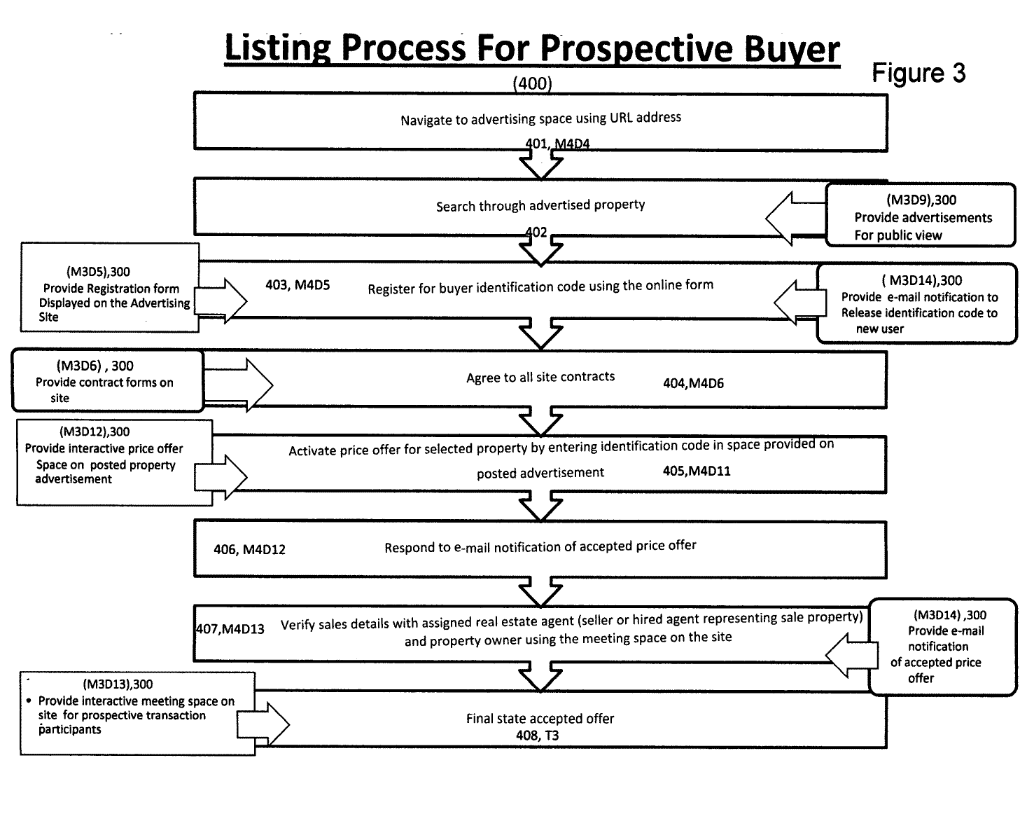

FIG. 3 is a perspective view of a buyer, such as a real property buyer 400. Eight transaction events are shown, 401 through 408, of the real property 10. This method and system of interactive, electronic commerce serves described affiliate named in FIG. 3 by providing buying space for property acquisition and comprises steps necessary for described user to finalize item purchase (IP).

The designation of a user is determined by information provided on the registration form as completed by the intended buyer participant The method and system utilizes a basic buyer user registration protocol that releases an identification code to inquiring participants upon completion of the registration form. The assigned identification code permits access to various pages/forms within the system's WWW database. The fluctuating variables engage the buyer/users with interactive parameters that optimize and drive the offer exchange opportunity toward the mutual objective of an acceptable offer for the advertised property. Registered users determine desired sale price for advertised items by selecting the sold button on the items advertisement space thus activating the system's transaction finalization protocol. By offering a unique property monitoring screen options to registered buyer users, multiple properties are viewed in one area on the site providing a more detailed price trend and individual analysis.

Each numbered transaction equation below provides a computational approach which represents the dynamics of this interactive process where certain indicators represent the sequential criteria necessary to achieve the end state system objective as defined by this model. This gives a firm bases for any simplification of the identifiable criteria to achieve the desired objective of a negotiation-free accepted offer as determined by both the seller and the buyer. Equation 2 sums the transactions illustrated in FIG. 3.

(M4D1, M4D2)+M4D4+M4D11+M4D12=T2 Equation 2

The affiliate defined in FIG. 3 completes all preliminary buyer's obligations commonly required by real-estate agents when buying a listed property utilizing a brokerage firm or similar agency.

M4D1 This method and system of the interactive, electronic commerce advertising space serves described affiliate M4D1 listed in field 403 of FIG. 3 by providing an identification code which permits the code entry into the purchase field on the public listing page for any advertisement released on the public viewing page of this system leading to finalization of the item sale (IS). The designation of a user is determined by information provided on the registration form as completed by the intended participant.

M4D2 This method and system requires all transactors described in M4D1 to provide proof of loan pre-approval upon system registration to receive designation code M4D1 classification. The system accepts .pdf files or uploaded forms in other formats of loan approval letters and also provides entry fields for lending agency contact information for seller's to verify entries if needed. Users are required to obtain all lending approval prior to registering as a designated classification represented in FIG. 1.

This system does link to other agencies providing quick loan approval quotes to users if needed provided prospective purchasers to meet required preapproval status for system registration purposes. The system only releases user codes to pre-approved users access to purchase opportunities.

M4D3 This method and system uses WWW address URL to advertise site location for prospective transactors.

M4D4 This method and system facilitates public viewing of advertised items for prospective transactors to search items of interest.

M4D5 This method and system provides links for viewers to access mortgage lending agencies' quick, loan-approval systems which is a prerequisite for said system registration.

M4D10 This method and system provides both public viewing for non-registered users, however, only those who have completed the registration process have the codes necessary to participate in the transactions available on this system.

M4D11 This method and system supports a transaction process in which the transaction is initiated simply by a registered user monitoring the price scale meter, as represented by FIG. 6, of a desired item until that items advertised price reaches the price point at which the said potential buyer is willing to pay. If buyer activates the sold icon within a described system for any listed advertised item, which immediately classifies that user as an active participant and commits that user to finalization of item sale. Obligates said buyer, by contract.

The system has individual price meters within every advertising space that are visible to the public. If multiple participants interested in the same item decide to purchase the item simultaneously the system will record the first purchase price received. The next price is also recorded and saved until the finalization of the item sale is complete and at that time both entries will be deleted from system. If the first transaction does not reach item sale, the next recorded price and code will be activated and both parties are notified and fulfill all agreed activities set forth by the method and system until final state is completed.

M4D12 This method and system provides an interactive space on the WWW site for finalization of possible IS for notified users who have agreed by contract to enter into said transactions as established by the registration protocol upon user site registration. Participants access site communication space using the accepted offer code disclosed in notification e-mail sent by the described site's administrative system to both participants involved in the interaction which allows access to the space provide to exchange further information regarding the possible property exchange. The site does not facilitate the final sale exchange and requires that both parties continue to final state sales transaction utilizing the listed real estate agent and off-site accommodations.

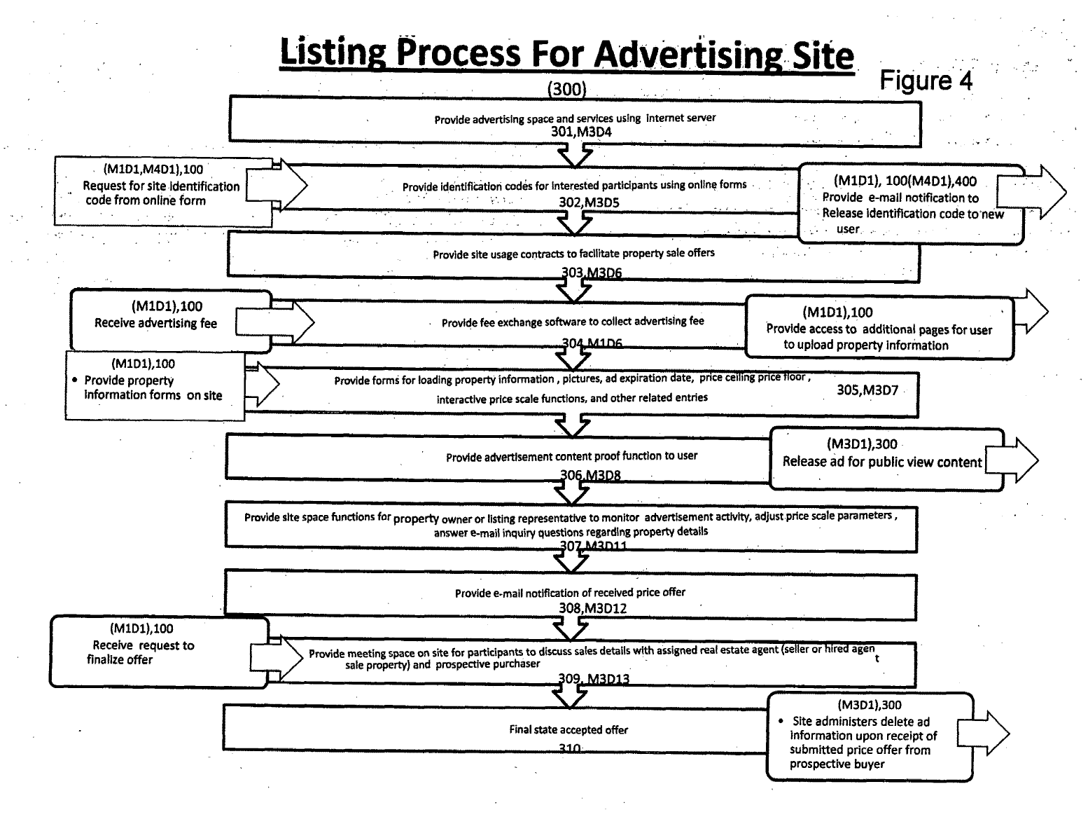

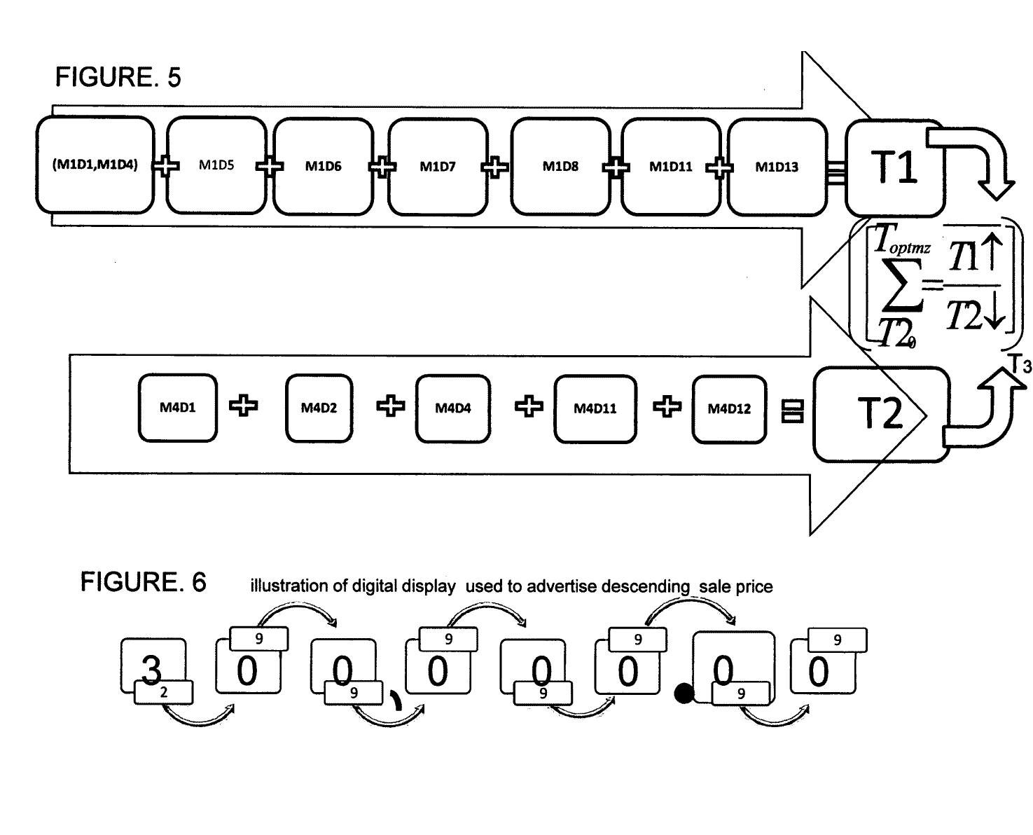

FIG. 4 is a perspective view representing the site's involvement displayed sequentially in this process where ten events are shown 301 through 310 of real property 10. This method and system of interactive, electronic commerce serves described affiliates named in FIG. 2 and FIG. 3 by providing sales transaction opportunities to users and comprises necessary steps for optimization of the final sale price for both parties as further described in FIG. 5.

M3D1 This method and system of interactive, electronic commerce serves described affiliate M3D1 and M1D1 listed in field 300 and 200 in FIG. 2 and FIG. 3 by providing advertisement space for sale property using a WWW site and database as the marketplace for the intended purpose of facilitating a price offer to buy the advertised property, and comprises steps necessary for described users to receive a sale price offer. Transactors access this system by the provided URL address. The designation of a transactor is determined by information provided on the registration form as provided by the site as listed on FIG. 4 and completed by the intended participant. Equation 3 sums the transactions illustrated in FIG. 4.

(M3D1, M3D4)+M3D5+M3D7+M3D8+/M3D9+M3D11+M3D12+M3D13+M3D14=T3 Equation 3: (T₃ Illustrated in FIG. 5)

M3D4 This transaction of the method and system includes transaction algorithms driving a transaction application that is hosted on a server such that an advertising space is provided for property owners and prospective buyers to determine an acceptable offer on advertised property. The users interested in purchasing properties listed on the site access the site registration pages by navigating to the advertising space using the advertised URL.

M3D5 This transaction of the method and system requires all transactors to register for an identification code, agent code, and a user payment account which are provided via e-mail notification and requires activation by the recipient. Access to listing forms is only permitted to those transactors with registration codes. Participants interested in initiating a price offer on a listed property are required to provide prequalification documentation to the site administration, via uploaded forms/entries, which accepts uploaded file submissions of loan acceptance letters form lending agency. The designation of the assigned codes depends on the personal information provided to the system by the transactor as filed on forms supplied by the WWW site. All license numbers are required in order for a transactor to receive an agent code or a broker code and listing fees are paid before further access is permitted. When a code is assigned the user is required to agree to advertisement listing fees/agent fees as set by system upon the accepted offer final state.

M3D6 This transaction of the method and system incorporates legal regulation by which listing providers are required to agree to all system contracts provided by the described site before further site navigation is permitted. The affiliate identified in FIG. 2 is required to designate a property representative which is responsible for providing and disclosing contact information such as e-mail address for system viewers to inquire for additional information via e-mail.

M3D7 This transaction within the method and system authorizes access to entry fields(posting forms in database) in the database for registered transactors described in FIG. 2 for posting legal descriptions of property, pictures, property, starting sale price, advertisement expiration date, listing representative or sales agents e-mail address, and item descriptions. Next, system parameters are provided by the site and set by the listing representative (seller/agent/designated representative) such as the sale price floor and initial setting of the rate at which the regressive price meter will drop the advertised sale price over the advertised time period. These parameters are not disclosed for public view and are for administrative use only. Upon completion of the user registration and product registration the entries are added to the site's database.

M3D8 This transaction in the method and system provides an interactive marketplace access using an advertised URL address for the World Wide Web where advertisements are edited and approved by both the listing representative and the system's administration. This step is regulated by the system's administration. All ad content requires the listing representatives approval before the listing is released for advertisement on the www server.

M3D9 The method and system provides administrative services to registered transactors and reserves the right to release property to the WWW server for view by the public upon completion of steps designated on FIG. 2, FIG. 3, and FIG. 4 of this method and system.

FIG. 5 is a flow diagram and an illustrative view of the method of the transaction optimization sequence determining T₃.

FIG. 6 is an illustrative view of the unique fluctuating regressive price scale formed in accordance with the present invention; and is a perspective view of the meter as it adjusts the advertised item's price.

M3D11 This transaction of the method and system provides a feature, as further represented in FIG. 6, regulated by the sale price listing parameter which has adjustable settings set by the listing representative (seller/agent/designated representative) such as the sale price floor, price descending amount, and price descending rate. The descending rate at which the regressive price meter will drop the advertised sale price are displayed on the property advertisement and are continually fluctuating, however, the other setting parameters listed above are not disclosed for public view and are for administrative use only.

M3D12 This transaction of the method and system will display an illuminated button which when selected by the user/affiliate described in FIG. 3 at the desired advertised property price will activate the price offer notification for both the seller and the prospective buyer.

M3D13 This transaction of the method and system provides an interactive space on the WWW site for finalization of possible item sale for notified users who have agreed by contract to enter into said transactions as established by the registration protocol upon user site registration. As described in statement above, said participants access site communication space using the accepted offer code disclosed in notification e-mail sent by the described site's administrative system to both participants involved in the interaction which allows access to the space provide to exchange further information regarding the possible property exchange. The site does not facilitate the final sale exchange and requires that both parties continue to final state sales transaction utilizing the listed real estate agent and off-site accommodations.

M3D14 This transaction of the method and system as described in FIG. 3 is responsible for deleting expired advertisements from the system's database or deleting advertisement listing which have received a price offer.

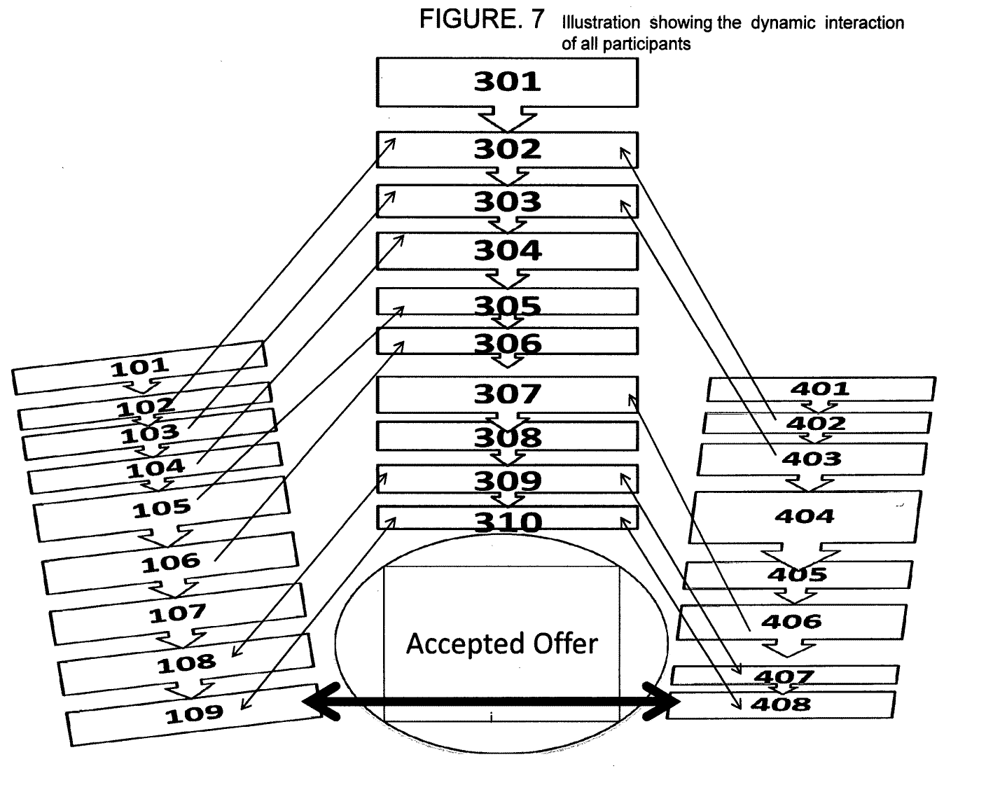

FIG. 7 is a perspective view of the sequential activities performed by designated participants utilizing this described method and system.

What is claimed is:

1. A method for determining optimized sale transaction price for advertised property, the method comprising:
an interactive, fluctuating, regressive, digital, sale-price display with adjustable parameters;
a digital advertising space, like internet or television, for property owners and prospective buyers;
a generation of acceptable offers on advertised property, wherein non-negotiated sale prices are determined using a regressive, sale-price scale and display;
a conversion of non-negotiated sale prices to accepted sale offers;
and creation of optimized property sales transaction for action by property owners, agents, lenders, and title companies.

2. The method of claim 1, further comprising:
a seller registration of property wherein the rate of sale price reduction is interactively controlled by the property owner;
a sale price reduction is displayed graphically for view by prospective buyers;
a lowest acceptable price is retained in a database awaiting comparison to descending sale price amount;
and a lowest acceptable sale price amount matches the descending sale price amount displayed on advertisement, the advertised property is no longer offered for sale.

3. The method of claim 1, further comprising:
a registration of a buyer wherein the interactive controlled and reducing sale price in the advertising space on a specific property is viewed by the registered buyer;
the reducing price viewed by the prospective buyer reaches the maximum value that the prospective buyer determines as an acceptable purchase price;
and an offer is interactively submitted by the buyer which stops further price reduction thus establishing the buyer's purchase offer.

4. The method of claim 1, further comprising:
buyer's submitted purchase offer matches the seller's advertised sale price;
a submitted purchase offer that is greater than or equal to the minimum seller's sale price, a purchase offer for a property transaction is optimized;
and an accepted offer is transmitted to the property seller.

5. The method of claim 1 wherein the property is any property.

6. The method of claim 1 wherein determining optimized sale transaction is performed by using the ratio of purchase offer to sale price determined to be near 1.0 but not greater that 1.0.

7. A computer program product for determining optimized property sales transactions, comprising:
an advertising space for property owners' sales prices, wherein declining sales prices are generated;
a graphically/digitally declining sale price displayed to potential prospective buyers, wherein acceptable offers are generated;
and an acceptable offer determined.

8. The computer program product of claim 7, wherein the processing component further includes:
a third item for determination of property sale optimization;
and a fourth item for transmission of accepted offers for action by the seller.

9. The computer program product of claim 7, further comprising:
a property owner user interface space provided within the computer program product that integrates with a processing component for alerting the seller when an acceptable offer is received;
a prospective buyer user interface space integrated with a processing component to submit acceptable offers;
wherein property owner user interface integrated with a processing component for halting of the price reductions upon receipt of an acceptable offer.
